(19) United States
(12) Patent Application Publication
(10) Pub. No.: US 2001/0028994 A1
(43) Pub. Date: Oct. 11, 2001

(54) METHOD OF MANUFACTURING AN OPTICAL DISK ORIGINAL RECORDING

(76) Inventors: SATORU FUKUOKA, YAMANASHI (JP); NOBUKI YAMAOKA, YAMANASHI (JP)

Correspondence Address: SUGHRUE MION ZINN MACPEAK & SEAS PLLC, 2100 PENNSYLVANIA AVENUE, WASHINGTON, DC, 20037

(21) Appl. No.: 09/324,051

(22) Filed: Jun. 2, 1999

(30) Foreign Application Priority Data
Jun. 2, 1998 (JP) HEI. 10-169313

(51) Int. Cl. G11B 7/26

(52) U.S. Cl. 430/330; 430/321; 430/320; 430/945

(57) ABSTRACT

An optical disk original recording is formed as follows: In a photo-resist layer forming step, a photo-resist layer is formed in such a manner that its thickness is much larger than the thickness which corresponds to a predetermined depth; and in a heating step, the photo-resist layer is heated at a temperature close to the melting point thereof, so that the surfaces of the recesses are fluidized to eliminate the rough surfaces, and the thickness of the photo-resist layer is decreased to a value which corresponds to the predetermined depth of the pits or grooves.

### BACKGROUND OF THE INVENTION

1. Technical Field of the Invention

This invention relates to a method of manufacturing an optical disc original recording which is necessary for the manufacture of reversible disks such as a DVD-RAM and DVD-RW, and more particularly to a technique for manufacturing a high-density recording optical-disk original recording.

2. Description of the Related Art

Optical disks include reproduction only type optical disks, and writable optical disks. Those optical disks are formed as follows: First, an optical disk original recording is used to form a nickel stamper by electro-casting. The stamper thus formed is employed to form a synthetic resin board by injection molding to which pits and grooves are transferred. And a recording film, a reflecting film, and a protective film are formed on the board thus formed. Thus, the aimed optical disk has been formed.

FIG. 4 is a diagram for a description of a conventional optical disk original recording forming method.

The above-described optical disk is manufactured through the manufacturing steps, shown in FIG. 4, using a well-known simple photo-etching technique. First, a positive type photo-resist layer is formed on a glass substrate having thickness of about 10 mm by a spin coat (phonetic) method. The thickness dl of the positive type photo-resist layer is set to a value approximately equal to the depth of the pits and grooves of the optical disk, for instance 10 to 50 nm (S21).

Next, a light beam which has been intensity-modulated with a recording signal is concentrated with an objective lens. Th concentrated light beam is used so that aimed exposure portions of the photo-resist layer which correspond to recording tracks of the optical disk are subjected to optical exposure, whereby a latent image corresponding to an light beam intensity distribution is formed (S22). Thereafter, the photo-resist layer thus processed is subjected to developing with an alkaline developing solution having a normality of the order of 0.2 to 0.3 N for several tens of seconds, so that recesses corresponding to the pits and grooves of the optical disk are formed (S23). Thereafter, the photo-resist layer on the glass substrate is washed (S24), and in order to improve the adhesion of the photo-resist layer to the glass substrate the photo-resist layer is heated at a temperature of the order of 80° C. for a predetermined period of time (low temperature baking). Thus, the optical disk original recording is formed (S25).

Let us consider the case where a high density optical disk original recording is manufactured according to the above-described method having track pitches of equal to or smaller than 1 μm, depths of pits and grooves of equal to smaller than 50 nm, and widths of the pits and the grooves of the order of 0.1 to 0.5 μm. In this case, as is well known in the art, the intensity distribution of the light beam used for exposure is a Gaussian distribution. Therefore, in portions other than the aimed exposure portions of the photo-resist layer, the optical energy of the light beam leaks, thus causing unwanted exposure.

FIG. 5 is a sectional view of a part of the optical disk original recording in the above-described state. FIG. 5A is a sectional view of the photo-resist layer formed on the glass substrate 101 in the exposure step (S22) of FIG. 4, and FIG. 5B is a sectional view of the recesses 103 in the photo-resist layer 102 which has been heated in the heating step (S25) of FIG. 4.

In the aforementioned exposure step (S22), the narrow aimed exposure portions of the photo-resist layer 102 shown in FIG. 5A is subjected to optical exposure. As a result, as shown in FIG. SB, the surface of the photo-resist layer 102 which has been subjected to developing, washing, and heating is roughened delicately. Hence, the recesses 103 corresponding to the pits and grooves of the optical disk are rough surfaces. Therefore, the pits and grooves of the resultant optical disk are also rough in surface configuration.

This difficulty is remarkable as the track pitch decreases, or the depth of the pits and grooves decreases, thereby degrading the C/N, and error rate of the reproduction signal of the optical disk.

### SUMMARY OF THE INVENTION

Accordingly, an object of the invention is to solve the above-described difficulty accompanying a conventional method of manufacturing an optical disk original recording. More specifically, an object of the invention is to provide a method of manufacturing a high-density optical disk original recording having minute pits and grooves by using simple techniques which are available today.

The foregoing object of the invention has been achieved by the provision of a method of manufacturing an optical disk original recording comprising:

a photo-resist layer forming step of forming a photo-resist layer on a glass substrate;

an exposure step in which a light beam modulated according to recording data is applied to the photo-resist layer, to form a latent image in correspondence to pits or grooves;

a developing step in which the photo-resist layer thus processed is developed to form recesses in the photo-resist layer in correspondence to the pits or grooves; and

a heating step of heating the photo-resist layer thus processed,

in which, according to the invention, with respect to pits or grooves having a predetermined depth to be finally obtained, in the photo-resist layer forming step the photo-resist layer is formed larger in thickness than the predetermined depth, and

in the heating step, the photo-resist layer is heated at a temperature close to the melting point thereof, thereby to decrease the thickness of the photo-resist layer to a value which corresponds to the predetermined depth.

The invention is designed as described above. Therefore, even if, in the developing step, the recesses corresponding to the pits or grooves are formed rough in the photo-resist layer, the difficulty is eliminated as follows: That is, in the photo-resist layer forming step, the photo-resist layer is formed in such a manner that its thickness is much larger than the thickness corresponding to the predetermined depth; and in the heating step, the photo-resist layer is heated at a temperature close to the melting point thereof, so that the surfaces of the recesses are fluidized to remove roughness from the surfaces, and the thickness of the photo-resist layer is decreased to a value corresponding to the predetermined depth of the pits or grooves. Hence, the pits or grooves having the predetermined depth can be formed with high accuracy.

### BRIEF DESCRIPTION OF THE DRAWINGS

FIG. 1 is a diagram showing optical disk original recording manufacturing steps according to an optical disk original recording manufacturing method of the invention.

FIGS. 2A and 2B are sectional views showing an optical disk original recording which is being processed in the aforementioned manufacturing steps.

FIG. 3 is a sectional view showing a part of a reversible double-layer optical disk which is formed with the optical disk original recording which is formed according to the method of the invention.

FIG. 4 is a diagram showing conventional optical disk original recording manufacturing steps.

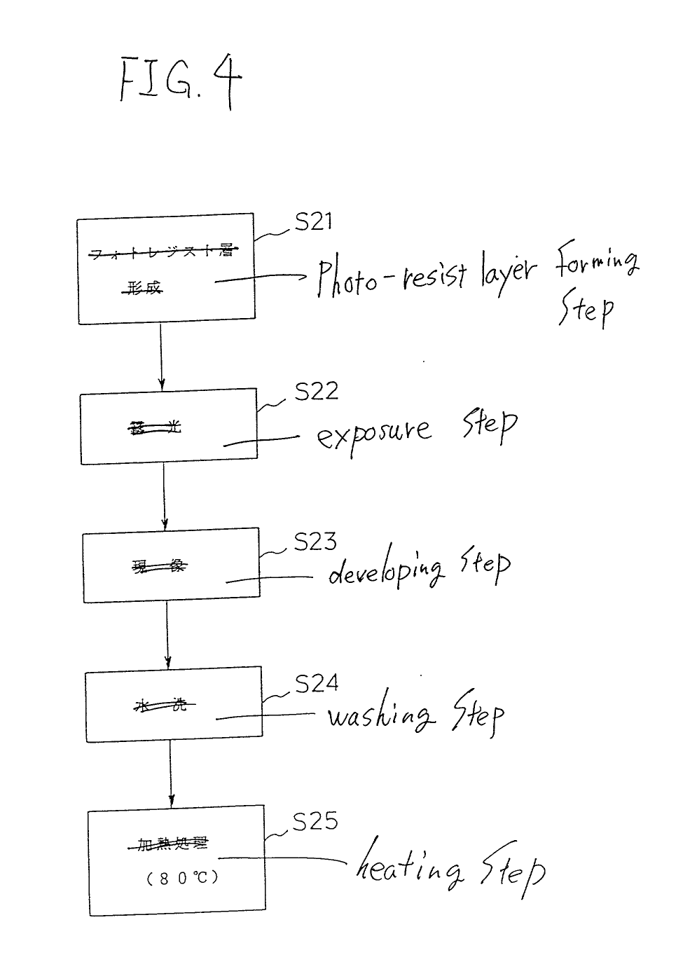

FIGS. 5A and 5B are sectional views showing a part of an optical disk original recording.

### DETAILED DESCRIPTION OF THE PRESENT INVENTION

The present invention will be described with reference to the accompanying drawings.

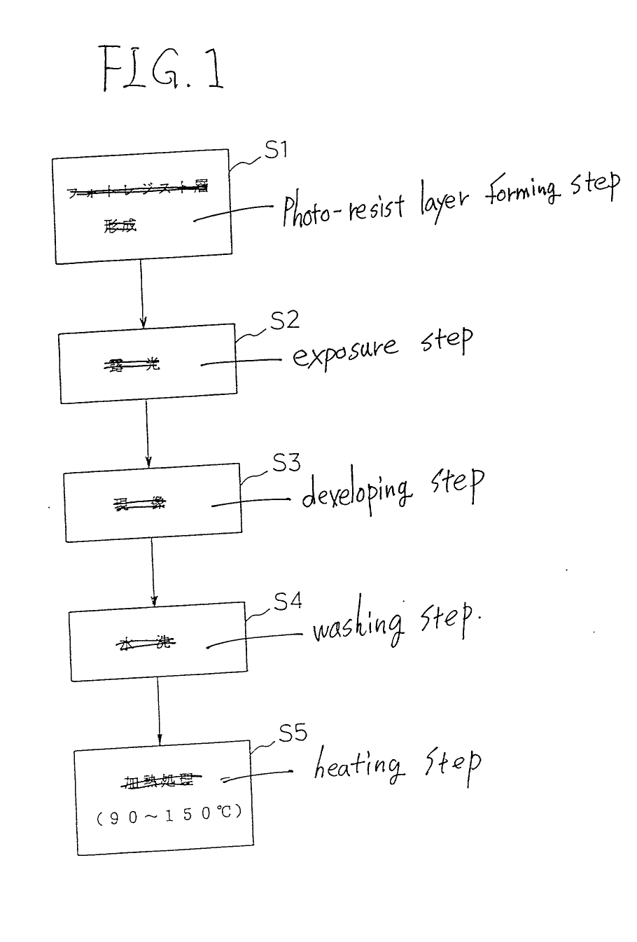

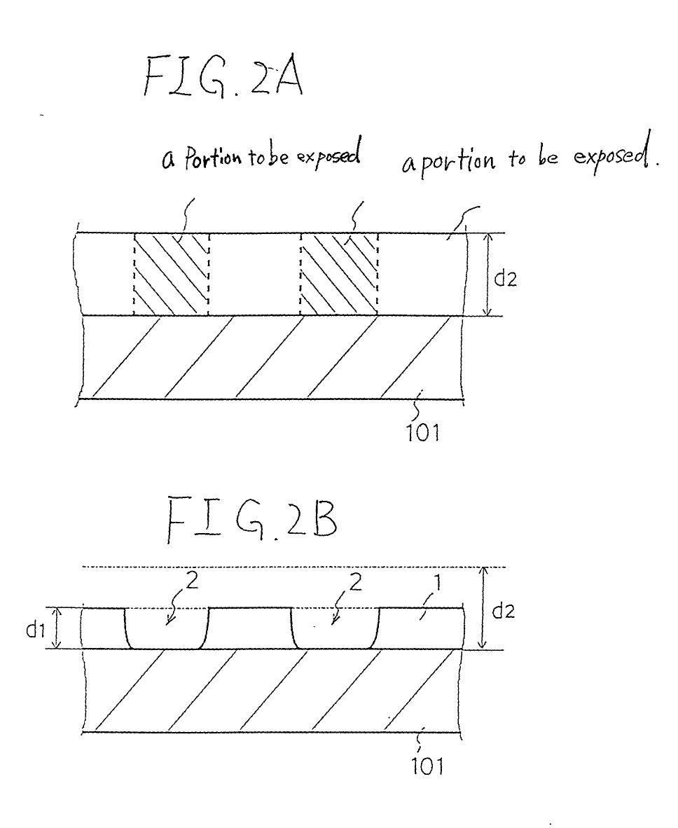

FIG. 1 is a diagram showing optical disk original recording manufacturing steps according to an optical disk original recording manufacturing method of the present invention. FIGS. 2A and 2B are sectional views showing an optical disk original recording being processed in the aforementioned manufacturing steps. More specifically, FIG. 2A is a sectional view of a photo-resist layer 1 formed on a glass substrate 101 in an exposure step (S2) in FIG. 1, and FIG. 2B is a sectional view showing the recesses 2 of the photo-resist layer 1 which is heated in a heating step (5) in FIG. 1.

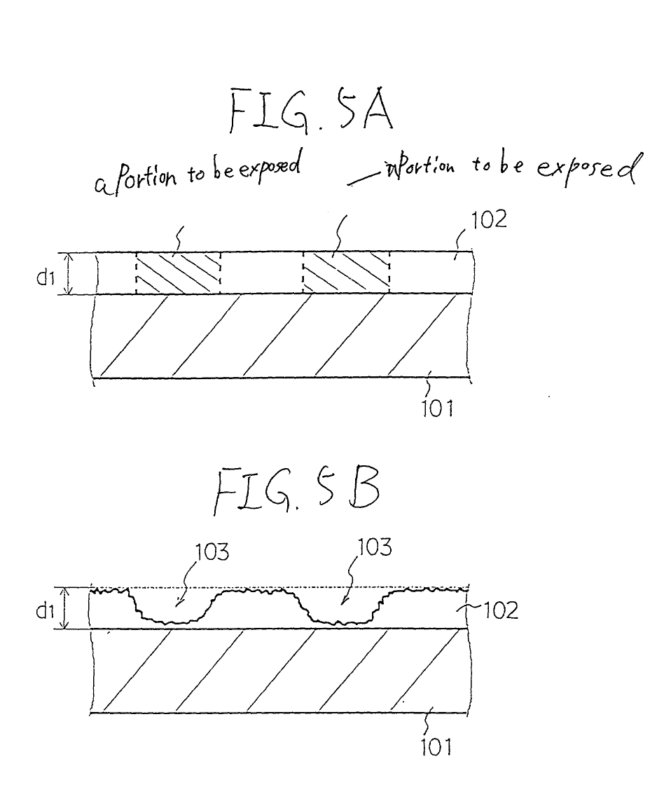

Now, the optical disk original recording manufacturing method will be described with reference to FIGS. 1, 2A and 2B. In FIGS. 2A and 2B, parts corresponding functionally to those already described with reference to FIGS. 5A and SB are therefore designated by the same reference numerals or characters.

First, in Step S1 (a photo-resist layer forming step), a positive type photo-resist layer 1 is formed on a glass substrate 101 (whose thickness is of the order of 10 mm) by a spin coat (phonetic) method. The thickness d2 of the positive type photo resist layer 1 is set to a value which is much larger than a thickness corresponding to the depth of the pits and grooves of the optical disk (for instance, to a thickness of the order of 55 to 100 nm).

Next, in Step S2 (an exposure step), the light beam intensity-modulated with a recording signal is concentrated with an objective lens, so that aimed exposure portions of the photo-resist layer 1, which correspond to the recording tracks of the optical disk, are subjected to optical exposure, whereby a latent image corresponding to the intensity distribution of the light beam is formed therein (cf. FIG. 2A).

Thereafter, in Step S3 (a developing step) the photo-resist layer thus processed is subjected to developing with an alkaline developing solution having a normality of the order of 0.2 to 0.3 N for several tens of seconds, so that the latent portions formed in Step S2 are removed, whereby recesses 2 corresponding to the pits and grooves of the optical disk are formed in the photo-resist layer 1. Next, in Step S4, the glass substrate together with the photo-resist layer is washed to remove the developing solution and other extraneous matters.

Next, in Step S5 (a heating step), the photo-resist layer 1 thus processed is heated at a temperature close to the melting point thereof (for instance, 90 to 150° C., preferably 120 to 150° C.) (a high-temperature baking process). As a result, the photo-resist layer 1 is gradually thermally contracted. Hence, the heating time is suitably adjusted so that the depth d2 of the photo-resist layer 1 becomes a predetermined value d1 (for instance 10 to 45 nm) which corresponds to the depth of the pits and grooves of the optical disk (cf. FIG. 2B).

Thus, the photo-resist layer 1 having the predetermined depth (which corresponds to the depth of the pits or grooves of the optical disk) can be formed readily and accurately. In addition, the photo-resist layer 1 is positively stuck onto the glass substrate 101.

In this case, the surfaces of the recesses 2 and the photo-resist layer 1 are fluidized in the heating step utilizing a temperature close to the melting point. Hence, the roughness formed in the exposure step is removed from the surface. As a result, the portions corresponding to the pits and grooves of the optical disk are formed accurately and readily.

In the above-described manufacturing process, the width of the pits and grooves are 0.1 to 0.5 μm, and the track pitch is 0.3 to 1.0 μm.

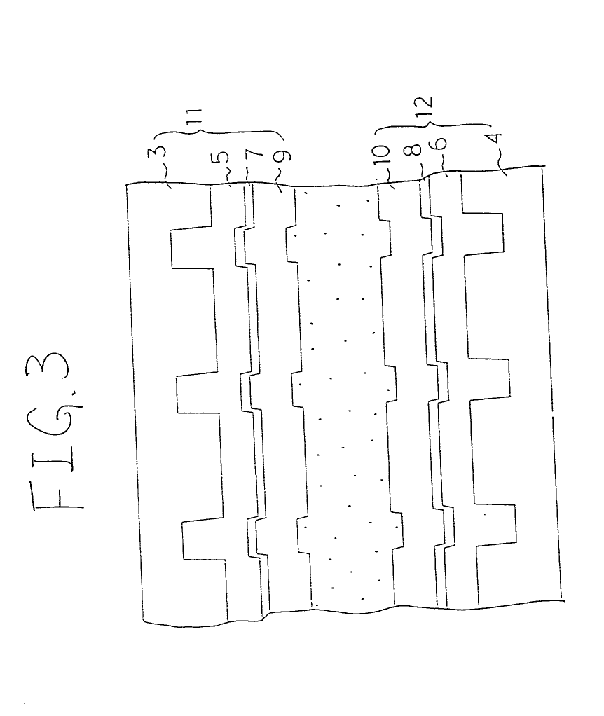

FIG. 3 is a sectional view of a reversible double-layer optical disk which is formed with the optical disk original recording which is formed as described above.

The double-layer optical disk is formed as shown in FIG. 3. That is, recesses 2 corresponding to the pits and grooves of the optical disk original recording (obtained by the above-described optical disk original recording manufacturing method) are transferred onto substrates 3 and 4, and recording films 5 and 6 (whose recording material is pigment) are formed on the substrates 3 and 4, and metal reflecting films 7 and 8 are formed on the recording films 5 and 6. Thereafter, the reflecting films are covered with protective films 9 and 10. Thus, two single-surface optical disks 11 and 12 have been formed. With the protective films 9 and 10 confronted with each other, the optical disks 11 and 12 are bonded to each other with adhesive agent. Thus, the aimed double-surface type double-layer optical disk has been formed. In this process, the recesses 2 of the optical disk original recording which has been formed with high accuracy are transferred onto the substrates 3 and 4, so that the pits or grooves having the predetermined depth are formed accurately.

In the above-described embodiment, the positive-type photo-resist layer is used in the exposure step, to form the recesses corresponding to the pits and grooves of the optical disk. However, the negative-type photo-resist layer may be employed in the exposure step, to form the recesses corresponding to the pits and grooves of the optical disk.

The invention is designed as described above. Therefore, even if, in the developing step, the recesses corresponding to the pits or grooves are formed rough in the photo-resist layer, the difficulty is eliminated as follows: That is, in the photo-resist layer forming step, the photo-resist layer is formed in such a manner that its thickness is much larger than the thickness which corresponds to the predetermined depth; and in the heating step, the photo-resist layer is heated at a temperature close to the melting point thereof, so that the surfaces of the recesses are fluidized to eliminate the rough surfaces, and the thickness of the photo-resist layer is decreased to a value which corresponds to the predetermined depth of the pits or grooves. Hence, the pits or grooves having the predetermined depth can be formed with high accuracy. Therefore, according to the invention, a high-density optical disk original recording can be readily formed by using a simple technique which can be utilized today. Furthermore, in the recording optical disk formed with the above-described optical disk original recording, the accurate recesses are transferred to form the pits and grooves with high accuracy. Hence, the reproduction signal of the optical disk which are based on those pits and grooves is improved in C/N and error rate.

What is claimed is:

1. A method of manufacturing an optical disk original recording comprising the steps of:
forming a photo-resist layer larger in thickness than a predetermined depth of pits or grooves to be finally obtained on a glass substrate;
applying the photo-resist layer with a light beam modulated according to recording data to form a latent image therein in correspondence to pits or grooves;
developing the photo-resist layer thus processed to form recesses in said photo-resist layer in correspondence to said pits or grooves; and
heating the photo-resist layer thus processed at a temperature close to a melting point of the photo-resist layer, to decrease the thickness of said photo-resist layer to a value corresponding to the predetermined depth.

2. The method as claimed in claim 1, wherein the pits or grooves are 10 to 45 nm in depth, 0.1 to 0.5 μm in width, and 0.3 to 1.0 μm in track pitch, and said photo-resist layer formed in the photo-resist layer forming step is 55 to 100 nm in thickness.

3. The method as claimed in claim 1, wherein, in the heating step, the photo-resist layer is heated at temperature of 90 to 150° C.

4. The method as claimed in claim 1, wherein, in the heating step, the photo-resist layer is heated at temperature of 120 to 150° C.
